(19) United States
(12) Patent Application Publication
(10) Pub. No.: US 2005/0283499 A1
(43) Pub. Date: Dec. 22, 2005

(54) Recruiting accession and paperwork management system

(76) Inventor: Larry Fowler, Alpharetta, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 11/148,660

(22) Filed: Jun. 9, 2005

Related U.S. Application Data
(60) Provisional application No. 60/580,579, filed on Jun. 17, 2004.

(51) Int. Cl. G06F 17/00

(52) U.S. Cl. 707/104.1

(57) ABSTRACT

A comprehensive recruiting accession and paperwork management application that provides near real-time leads transfer, one-time data entry capability, command control and reporting capability, seamless paperwork processing and management, and full ODBC compliant communications capability.

### CROSS-REFERENCE TO RELATED APPLICATION

To the full extent permitted by law, the present application claims priority to and the benefit as a non-provisional application to provisional patent application entitled “Recruiting Accession and Paperwork Management System” filed on Jun. 17, 2005, having assigned Ser. No. 60/580,579, wherein said application is incorporated herein by reference.

### COPYRIGHT NOTICE AND LIMITED AUTHORIZATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present invention relates generally to a recruiting program. More specifically, the present invention is a comprehensive recruiting accession and paperwork management application that provides near real-time leads transfer, one-time data entry capability, command control and reporting capability, seamless paperwork processing and management, and full open database construction (ODBC) compliant communications capability.

### BACKGROUND OF THE INVENTION

Each military service, including Reserve and National Guard components, utilizes some sort of command and control software package. Such packages vary greatly in scope and function depending on the command structure of the service component, the size of the organization, and the requirement of their recruiting staff. Unfortunately, available software packages fail to address the needs of the accession community in a complete and comprehensive manner.

Most systems were originally designed as C3I programs (Command, Control, Communication and Intelligence), with heavy emphasis on control. Early systems were intended primarily to be used at the service headquarters or recruiting command level to manage the flow of recruits through their recruiting processes and to manage quotas and training positions. Initially, little or no effort was made to interface these systems with the recruiting workforce and recruiters. Middle level personnel were, and in many cases still are, reporting to these systems via paper reports that must be manually input when received. Data transferred to outside systems also occurred via paper reports, as no electronic data links were provided.

More recently, technological advances in data processing has made it feasible to expand these systems to include third party links and recruiter interfaces. Attempts have been made to add these components or functions to existing service systems; however, the results of such efforts have been generally poor. Consequently, there is currently no service system that incorporates all aspects of the recruiting mission in a comprehensive manner, wherein bridges to outside systems are provided, and wherein a recruiter/mid-level manager interface is provided that is complete and intuitive.

In general, available service systems are deficient in one or more of the following areas: command and control, information gathering and reporting, transfer of lead information to the recruiting force, forms processing, and/or links to outside systems. Although designed specifically for command and control, most systems fall far short of expectations. Such systems were mostly built on older technologies that do not allow for the rapid modifications required in the dynamic recruiting environment. Therefore, what is needed is a flexible system that can be easily and inexpensively modified and updated to allow for rapid response to changing conditions.

Available service systems also struggle with information management. Most systems rely on reports submitted by recruiters, which must be entered into the program at some point. This process is very labor intensive and must assume that the recruiters are reporting accurately. Despite the importance of recruiter reports, most systems lack a recruiter “feed-back” mechanism, thereby making it difficult to gather lead demographic data, test score information, media effectiveness information, and other important information which can only be input at the recruiter level. Therefore, what is needed is a “closed loop” system that has an intuitive and “user friendly” recruiter interface as an integral component. Information needed by service personnel managers can thereby be made available via the normal recruiting process, wherein no separate reporting is required. This would not only reduce the manpower required for obtaining this data, but would also result in a verifiably accurate data set, given that all data would be captured at the time of need and would not need to be reentered at any point in the processes.

Furthermore, available service systems fail to provide the recruiting workforce with “real time” or “near real time” information on prospective recruits. A great deal of effort and money goes into the generation of leads. Military services spend millions of taxpayer dollars on advertising and promotional campaigns every year in an attempt to urge interested persons to visit the respective service web sites, phone centers, chat rooms and other contact points. The challenge is to convey information on prospective recruits to the “salesmen” (i.e., recruiters) in a timely manner so that the leads may be contacted and “sold” while the interest remains high. Some services slowly transmit lead information to recruiters via surface mail while other services rely on facsimiles or telephone calls from higher levels in the system. However, what is needed, is an expedited system that allows lead information to be transmitted almost instantly to the recruiting workforce so that recruits may be contacted in the shortest possible period of time.

Furthermore, military recruiting is a very “paper intensive” process. The typical recruit paperwork package contains over two hundred pages and up to fifty different forms. Such forms come from several sources, including the Office of Personnel Management, the Military Entrance Command, and the Department of Defense. Current service systems lack a mechanism for the smooth processing of recruiting forms. Most services manually type information from these forms into their systems, which in addition to being extremely labor intensive, inefficient and costly, often results in improperly entered forms. Moreover, data that is common to all of the recruiting forms, such as name, Social Security Account number, and gender, must be entered into the system repeatedly.

Of further need is a system that compiles recruit information into a centralized database, wherein the required documents may be generated as needed. Such would allow for “one time data entry”, wherein data, such as a name, is captured once, and then parsed to all documents as needed. The compilation of recruit information into a centralized database would facilitate form management to ensure that the recruiter is receiving the most current and accurate information. Further, the forms could be obtained in an easy-to-use format wherein the form fields would be validated to ensure that information is being input correctly.

In addition, available service systems do not enable the easy transfer of data from the service database to other entities. It has recently become apparent that a need exists to share and move data between the military service and other government agencies. Currently, data must first be sent to the Office of Personnel Management via paper forms. Of preference would be a safe, secure, and dependable data exchange link from the service system to other authorized databases. This process must meet all security, HIPAA and Privacy Act requirements, yet remain flexible and updateable. The movement of data across such systems must also be automated and verified for accuracy.

Therefore, it is readily apparent that there is a need for a service system that covers all aspects of the recruiting mission. Such would involve a service system that addresses the current deficiencies in recruiting leads processing, tracking and reporting, forwarding of leads to recruiters, marketing and sales analysis, recruiter effectiveness and workload tracking and control, business rule enforcement and dissemination, applicant tracking and processing, recruiting forms management and dissemination, forms processing, filling, printing and forwarding, recruit information management and reporting, and automated information transfer to parties outside of the recruiting command structure.

### BRIEF SUMMARY OF THE INVENTION

Briefly described, in a preferred embodiment, the present invention overcomes the above mentioned disadvantages and meets the recognized need for such a device by providing a comprehensive recruiting accession and paperwork management application that provides near real-time leads transfer, one-time data entry capability, command control and reporting capability, seamless paperwork processing and management, and full ODBC compliant communications capability.

According to its major aspects and broadly stated, the present invention in its preferred form is a comprehensive recruiting accession and paperwork management application comprising, in general, a web-based, thin client, application utilized primarily for command, control and reporting purposes, and a compiled code, thick client, application utilized to manage lead information, capture lead information, maintain data for paperwork processing or CRYSTAL REPORT generation, and provide data warehouse for recruiting and other party use.

More specifically, the present invention is a system of websites, databases, reports, administrative interfaces, and offline software components, designed to be utilized by various Coast Guard personnel, or other recruiting agencies, to manage the status of potential recruits through the entire life cycle of the recruits' interests. The system includes capturing lead information about a possible recruit's interest from a variety of sources, including incoming telephone marketing, website entry of data, entry of leads by individual recruiters, and transfers of data from other sources. Incoming data is stored in a central database, which acts as the official data repository of all data captured on each lead.

National lead data comprises lead information that originally enters the system via web sites, third party data feeds, or telephone service representative (TSR) entry, whereas local lead data comprises lead information that enters the system via manual input by recruiters. Additionally, all incoming leads are automatically assigned to “areas of responsibility” (AORs), based on zip code and other geographical information, and are further automatically assigned to individual recruiters in those AORs, as specified in assignment rules optionally defined and maintained by each AOR's “recruiter-in-charge” (RIC).

Numerous predefined reports are automatically generated, utilizing stored procedures, and made available to the command staff utilizing customized active server pages (ASP) available to authorized users via the Internet. Lead data is made available to recruiters and merged into the compiled code, thick client, application to allow for the completion of the accession paperwork. Data gathered during the package preparation process is also available for reporting purposes.

Accordingly, a feature and advantage of the present invention is its command and control features. More specifically, the closed loop lead system enables lead information to be tracked and reported throughout the recruiting process, thereby allowing the recruiting command to accurately track advertising expenditures and to manage incentives, such as, for exemplary purposes only, schools, bonuses, advanced and pay-grade enlistments.

The present invention allows a user to determine the number of leads generated, the quality of leads generated, the cost per lead, the cost per qualified lead, the cost per enlistment, the number of enlistments resulting from a campaign, and very specific demographic data on such leads. For example, a user can determine the number of minority females that responded to an advertisement, the number of such females that were qualified, the number of such females that actually enlisted, and the costs associated with recruiting such females. This feature allows for an extremely targeted and effective marketing effort.

The control and command features of the present invention also allow users to gather specific information concerning all aspects of the recruiting process. For example, a user can determine the locations in the process where attrition is the highest and enable the command staff to identify possible methods of reducing the attrition rate. Moreover, recruiter activity and effectiveness can also be observed, which would allow the recruiting command to better manage the recruiting workforce.

Military recruiting is a very dynamic environment with constantly changing requirements and conditions. As such, the present invention is designed to be flexible, resilient and allow for rapid response to changes to the recruiting process, without having to reengineer the software systems. Such features not only allow for quick realignment, but are also very cost effective.

Another feature and advantage of the present invention is its information gathering and reporting capabilities. Specifically, the present invention contains over 5,000 data fields, all of which can contain useful information, wherein information may be gathered and entered into the system as a normal part of the recruiting process. Thus, no additional reporting is required on the part of the user, thereby greatly reducing the manpower normally associated with current recruiting systems. The present invention also comprises a user-friendly and intuitive user interface, wherein feedback may be quickly and easily transmitted to the decision makers and users. Reports of varying complexity can be generated, wherein the reports may further be easily modified.

Yet another feature and advantage of the present invention is its ability to transfer lead information to the recruiting force. It is of paramount importance that a recruiter contacts a potential applicant as soon as possible after the applicant has requested information. Accordingly, the present invention is designed to receive recruiting lead information from a variety of sources and pass the information to the recruiting force almost instantly. More specifically, once lead information is received from a website, mail-in card, telephone call, or other recruiting means, the lead information is screened for obvious disqualifying conditions and immediately routed to the appropriate recruiting office. The lead is then either assigned to a specific recruiter by the Recruiter in Charge of that office or through an automated process.

Still another feature and advantage of the present invention is its forms processing feature. To manage the extensive amount of paperwork required during the recruiting process, the present invention presents recruiting forms to the user in a very intuitive and user-friendly format. When a specific form is requested, the current, most up-to-date form is presented to the user so that the user can then plainly see what data is needed. When a recruiter enters data into the database, the data is stored and automatically parsed out to any subsequent forms that also require the same data.

In addition, because paperwork and forms change often, the present invention is designed to be easily updated when changes occur. When a form change occurs, the new form is developed and placed into the system at a central location, wherein the new form is subsequently distributed to all users instantaneously.

Still yet another feature and advantage of the present invention is its ability to link to outside systems. The present invention stores data in open database construction (ODBC) databases, which enables the easy export to or import from external data systems. Moreover, all data is easily convertible to XML format.

Another feature and advantage of the present invention is its portability. Because recruiters are often required to travel, the present invention allows for complete applicant processing from a recruiter's laptop computer whether an Internet connection exists or not. A synchronization procedure is then provided to ensure that information obtained from a recruiter is shared between the system's national and local databases. Such synchronization is small enough to be performed over a dial-up connection, yet powerful enough to efficiently transfer a large amount of data.

Yet another feature and advantage of the present invention is its data redundancy. Because applicant data is stored in both local and national databases, any lost data can be quickly restored.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a flow diagram of the system according to a preferred embodiment of the present invention.

### DETAILED DESCRIPTION OF THE PREFERRED AND SELECTED ALTERNATIVE EMBODIMENTS

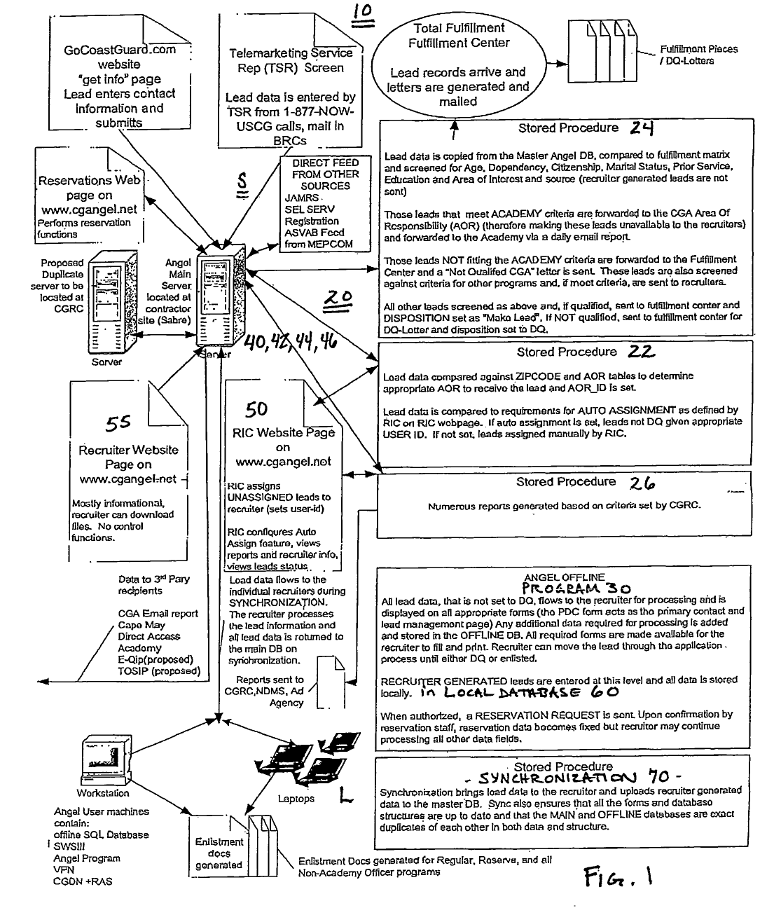

In describing the preferred and selected alternate embodiments of the present invention, as illustrated in FIG. 1, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIG. 1, the present invention in a preferred embodiment is a recruiting accession and paperwork management system 10, wherein system 10 preferably is a comprehensive application designed to automate the military recruit accession process. Preferably, system 10 generally comprises online program 20, structured as a web-based thin client application utilized primarily for command, control and reporting purposes; and, offline program 30, structured as a compiled code, thick client, application utilized to manage lead information, capture lead information, maintain data for paperwork processing or CRYSTAL REPORT generation, and provide data warehouse for recruiting and other party use. System 10 is designed to operate over a high-speed internet connection or a simple dial-up connection, and involves much behind-the-scenes communication for FTP transfers, emailing of reports and files, automatic updating of program versions, and synchronization of data, as more fully described below.

More specifically, through online program 20, lead information about a possible recruit's interest is captured end entered from a variety of sources S, including incoming telephone marketing (i.e., telephone service representative (TSR) manual entry), website entry of data, entry of leads by individual recruiters, and transfers of data from other sources. Preferably, “national lead data” comprises lead information that originally enters system 10 via web sites, third party data feeds, or TSR entry, whereas “local lead data” preferably comprises lead information that enters system 10 via manual input by recruiters. Although such national lead data is gathered though several disparate sources, all national lead data is stored in master database 40, which acts as the official data repository of all national data captured on each lead. Local lead data is preferably stored in a local database 60, wherein all lead information from master database 40 and local database 60 are preferably merged via synchronization process 70 into offline program 30 to allow for the completion of the accession paperwork and/or reporting purposes. It is contemplated that all data may be stored in the user's local MSDE database, depending on the point of origin.

For exemplary purposes only, and to illustrate the functions of online program 20, national lead data entered into the Coast Guard Recruiting web site lead information page is captured upon submittal, and transferred to master database 40 by the intrinsic ASP code built into the Coast Guard Recruiting web page, wherein the lead data is preferably stored in either PDC table 42 or TMASTER table 44 of master database 40. National lead data from telephone service representatives (TSRs) is also similarly stored in either the PDC or TMASTER tables 42,44, respectively. Data manually entered by the recruiters into offline program 30 also moves to PDC and TMASTER tables 42, 44, respectively, as more fully described below. Each new lead record entered into master database 40 is given a unique identifier (PDC_ID) upon creation of a new row in TMASTER table 44.

Upon entering system 10, national lead data is preferably evaluated to determine the appropriate recruiting office (RO) in which to assign the lead record for follow-up. Preferably, each RO resides within a well defined “area of responsibility” (AOR), or territory, and each AOR is assigned an identifier or AOR_ID. Preferably, stored procedure 22 is automatically triggered upon update of master database 40 information with new lead information that extracts zip code information from the incoming data and compares that number against a zip code table. The zip code table contains information relating to the AOR assigned to each RO, wherein stored procedure 22 sets the value for the AOR_ID in the TMASTER table 44 to the value for the appropriate AOR. As such, the lead record is assigned to the RO that corresponds with the zip code. Accordingly, the data is then preferably made available for reporting purposes.

Preferably, stored procedure 24 ensures that all lead information is screened against a matrix of minimum enlistment standards before being made visible to recruiters, wherein lead information that falls outside of the acceptable ranges are set to a disqualified disposition and flagged as being disqualified. Preferably, although not available to recruiters, disqualified lead information is assigned to an AOR-ID and is included in the recruiting reports.

Preferably, if a lead record meets the minimum standards, the lead record is made available to the recruiter-in-charge (RIC) of the appropriate RO (based on AOR_ID) through central website 50. Each RIC is assigned a user name and password, which is stored in TUSER table 46 of master database 40. The RIC logs onto central website 50 with his/her username and password, wherein the ASP code of the log-on screen queries TUSER table 46 (via an ODBC connection and a view) and compares the username and password with the information contained in TUSER table 46. If the entered username and password match, the view also looks at the “security role” assigned to the user, and opens the appropriate ASP page, in this case a RIC Welcome page.

Because the RIC for each RO is tasked with lead assignment to his/her subordinate recruiters, through central website 50, the RIC can view qualified lead records and manually assign the lead records to a subordinate recruiter assigned to the corresponding AOR, or, alternatively, the RIC may opt to have the incoming leads automatically assigned to subordinate recruiters utilizing an “automatic lead assignment process” (ALAP).

To manually assign a lead, the RIC utilizes an “UNASSIGNED” button located on the RIC welcome page of central website 50. When the RIC clicks or selects the “UNASSIGNED” button, a view queries TMASTER table 44 for records that have the appropriate AOR_ID. The last, first and middle names of the matching AOR_ID records are displayed on an “UNASSIGNED” screen of central website 50, and are presented in chronological order, based on the date the lead entered the system (i.e., “REFERRAL_DATE”, as displayed on central website 50). Accordingly, the RIC may select a lead record from the “UNASSIGNED” screen for manual assignment by clicking on the name, wherein a “LEAD INFORMATION” screen will then open, and a view will query and display the pertinent lead information (name, address, phone number, age, education level, gender, race, etc) The RIC can assign the lead to a specific recruiter by selecting the recruiter's name from a drop down menu (view generated from the TUSER table 46), and clicking an “ASSIGN LEAD TO” button. The ASP code sets the value in the USER_ID field to the value for a USER_ID associated with the selected recruiter (i.e., TUSER table 46). This lead record is now available for download into offline program 30 during synchronization process 70, as more fully described below. Note that no leads will be included in synchronization process 70 unless both the AOR_ID and the USER_ID are set.

Alternatively, the RIC may opt to have the incoming leads automatically assigned to recruiters utilizing the ALAP, wherein the ALAP automatically assigns a USER-ID to the lead record. Automatic assignment consists of a series of views and stored procedures that allow the RIC to predetermine lead assignment based on specific criteria, wherein the criteria may include, for exemplary purposes only, race, gender, zip code, city, state, or area of interest. For example, by aligning the criteria with the assigned subordinate recruiters, the RIC can automatically assign all female leads to a female subordinate recruiter. As such, through the ALAP, leads that meet certain criteria are preferably transferred to the appropriate subordinate recruiter without RIC involvement.

To utilize the ALAP, the RIC sets lead “profiles” by clicking on a “SET PROFILES” button of the “UNASSIGNED” screen. This opens a window that allows the RIC to set lead profiles that will assign USER_ID values to lead records based on the priorities and values selected. When the profiles have been set, a stored procedure automatically assigns the appropriate USER_ID upon creation of a new record; thereby, eliminating further RIC intervention. The leads are then available for synching through synchronization process 70 of offline program 30, as more fully described below.

Still, in addition to the lead assignment process described hereinabove, other features of online program 20 include a “DISPOSITIONS” button, which, when selected, opens a window within the RIC welcome page of central website 50 that displays a set of disposition options (i.e., disposition is defined herein as the level of processing to which a lead is progressed). When a disposition is selected, a view recovers from master database 40 a list of all lead records that contain the AOR_ID for a particular AOR, and displays the lead name in an ASP page. The ASP page displays the LEAD NAME, DISPOSITION (based on the current value in a “DISPOSITION_AUTO” field), and the name of the recruiter to whom the lead is assigned (based on the value in the USER_ID field). Other features of online program 20 are: the “REPORTS” functions, which makes available to the RIC a series of pre-defined CRYSTAL REPORTS (a third-party proprietary Business Intelligence application utilized to gather data and design reports based on a wide scale of data sources, such as databases like MICROSOFT SQL SERVER, MICROSOFT ACCESS and ORACLE, spreadsheets like MICROSOFT EXCEL, text files, groupware applications such as MICROSOFT EXCHANGE and LOTUS NOTES, as well any other data source accessible through ODBC or OLAP); and, a “Rolodex Contact Manger” that may be utilized by the RIC as needed.

Through online program 20, each subordinate recruiter also has access to all leads assigned to him/her and can query and generate reports on lead activity. The pages 55 through which the subordinate recruiters may access the leads function in a similar manner to the RIC pages, but do not contain the command and control functions, such as lead assignment. Additionally, the subordinate recruiters have access to a “DOWNLOADS” page where the subordinate recruiters can download files, forms or maintenance tools. Furthermore, even when a lead record is downloaded to offline program 30, information may still be gathered relating to the final disposition, value and relevance of the lead, wherein such information is reported to the recruiting command at every step of the recruiting process, thereby “closing the loop” of data flow. Leads generated at the recruiting level are also preferably reported back.

Preferably, once the lead record assignment process has been completed, or a lead is entered into offline program 30, and the lead has a USER_ID assigned, the record is positioned to be brought into the paperwork management module. Data is preferably moved between national database 40 and local database 60 utilizing custom synchronization process 70. Recruiters may preferably trigger synchronization process 70 by logging onto system 10 and selecting a “SYNC” icon from the desktop icon bar. Recruiters may log onto system 10 and central website 50 utilizing a unique username and password combination. Preferably, upon selection of the “SYNC” icon, a “SYNCHRONIZATION” screen is displayed, wherein the recruiter may press a “SYNCHRONIZE PROGRAM” button to initiate synchronization process 70.

Briefly described, synchronization process 70 preferably compares national database 40 with local database 60 and brings the two databases into alignment. All leads that enter system 10 at the national level are preferably assigned a unique Prospect Data Card identifier, or PDC_ID. Preferably, if a lead record having a particular PDC_ID is not present on local database 60, but is present on national database 40, synchronization process 70 adds the lead data corresponding to the particular PDC_ID to the appropriate tables in local database 60. Preferably, if a lead record is entered at the local level, it is given a temporary PDC_ID until synchronization process 70 is initiated, wherein, upon synchronization, the record receives a permanent identifier. If a record exists on local database 60 with a temporary PDC_ID, the lead data is preferably inserted into the appropriate tables on master database 40. Preferably, if a lead with the same PDC_ID exists on both databases 40, 60 due to a prior synchronization, synchronization process 70 compares the “LAST_UPDATED” and “LAST_SYNC” fields in the lead record to determine which data should be given precedence over the other, wherein the lead record having the youngest “LAST_UPDATED” date is assumed to be the most current and overwrites the other. Such a process also preferably reduces the amount of data transferred and the time consumed by synchronization process 70, since only data that has changed is synchronized. Synchronization process 70 is also preferably utilized to update the local user's code, forms and other features. Preferably, new files or modified forms are downloaded and installed, as well as code updates and database structure modifications.

Additionally, each recruiter can download his assigned incoming leads from the central database into a local copy of the database, stored on the recruiter's laptop computer. Once this synchronization is done, the local database can be used in a completely offline mode, either in the recruiting office, or even out in the field, such as in a home meeting with a potential recruit. Synchronization process 70 goes far beyond the usual replication involved in conventional offline database systems, in that synchronization process 70 can handle automatic changes to the structure of databases 40,60—a critical need in the ever-changing world of recruitment paperwork. Newly added or revised forms are also automatically downloaded during synchronization process 70, as are the latest program updates to keep recruiters current on all added functionality and “bug” fixes.

More specifically, synchronization process 70 is a core function of system 10. By initiating synchronization process 70, the recruiter accomplishes the following (Note: all synchronization functions are triggered by comparing “LAST_UPDATED” and “LAST_SYNC” date-times between master and local databases 40, 60, respectively, wherein in most cases, the “YOUNGEST” date-times will have precedence and either overwrite information of the other database, or cause a function to trigger):

Total Database Structure Check: The program manager may make modifications to master database 40 that requires a specific SQL script to be run on local database 60. The program manager may request this change by adding a row to the “TDB_CHANGE” table on master database 40. If a “NEW” row (date-time contains a value “YOUNGER” than the “LAST_SYNC” date on local database 60), then the appropriate script will run. Thus, the foregoing is a manually triggered function that does not occur during every synchronization implemented.

Database Structure: The program manager may, at any time, make modifications to master database 40 (add/remove a table, add/remove fields, etc.). A “database structure” check compares the tables, column by column, to the tables located on master database 40, and automatically launches various SQL scripts to bring local database 60 into alignment, structurally, with master database 40. The foregoing may include removing tables, adding tables, modifying existing tables by adding or removing columns, and the like. The instant function does not compare data at this point, only system architecture. Additionally, the instant function is performed at the beginning of every synchronization to ensure that subsequent steps will not be interrupted due to database misalignment.

Tables Check: The “tables check” function checks to ensure that all the tables that are found in master database 40 also exist on local database 60, wherein if a table is not found on local database 60, a script runs to add same.

Files Check: The “files check” function compares documents within local database 60 directly with a “TFILES” table within master database 40. Any XFML files that are listed in the TFILES table, but are not present in a documents directory of local database 60, are automatically downloaded via FTP from the main server and installed. This ensures that the recruiter always has the most current versions of the XFML files and that new XFML files are added to the offline function when needed. The file transfer is controlled by manipulation of the TFILE table by the program manager.

Leads Transfer From Server: Any leads, whose AOR_ID and USER_ID values are set to a particular recruiter by lead assignment processes (i.e., manual or automatic), will be downloaded to the appropriate tables in local database 60. It should be noted that every lead that enters system 10 from a national lead source (e.g., TRS input, website input, or flat file), is assigned a unique identifier number (PDC_ID). The sync function first looks in TMASTER table 62 of local database 60 for a row containing the relevant PDC_ID. If none exists, the row is added to local database 60, and the LAST_UPDATED/LAST_SYNC date-times are set to server time. If a row containing the PDC_ID exists, the process compares the LAST_UPDATED/LAST_SYNC date-times and determines which is YOUNGER. If the server contains a “younger” lead, the associated rows on local database 60 are overwritten with the data found on master database 40. If the record on local database 60 is younger, master database 40 is overwritten; thus, ensuring that both databases 40, 60 contain identical data and that the most recent data entered is maintained.

Leads Transfer From Local Sources: As described above, lead records can originate from local sources as well, and the recruiter may enter lead data directly into offline program 30. This locally generated information must be moved to master database 40 for use in reporting and to allow master database 40 to act as a remote backup for local database 60. When a lead record is initiated locally, it is assigned a temporary PDC_ID so that the lead information across tables can be tracked and the lead record maintained. Synchronization process 70 identifies leads that contain temporary PDC-ID values, and creates a new row in the appropriate tables on master database 40. The temporary PDC_ID is overwritten by a permanent PDC_ID assigned by master database 60. Thereafter, the lead will be updated or modified based on date-times as described above.

Leads Transfer To Other Recruiters: By pressing the “TRANSFER” button in offline program 30, the recruiter can select a lead record to transfer to another recruiter in his own AOR. The “TRANSFER Screen” reads the AOR_ID contained in this record and a view displays the corresponding recruiters from the TUSER table. By clicking on a recruiter's name, the sending recruiter designates the receiving recruiter. The program sets the USER_ID to the new value and changes the LAST_UPDATED date for the record. Synchronization process 70 overwrites the record in master database 60, as described above. When the receiving recruiter syncs, he/she will receive the lead into his/her own personal or offline database.

Leads Transfer To Other AOR: By pressing the TRANSFER button in offline program 30, the recruiter can select a lead record to transfer to another AOR. The transfer screen provides a list of all the AORs, wherein by clicking on an AOR name, the sending recruiter designates the receiving AOR. The program sets the AOR_ID to the new value, changes the LAST_UPDATED date for the record and sets the USER_ID to “NULL”. This forces the lead to appear on the UNASSIGNED screen of the RIC website at the receiving AOR after synchronization. The RIC at the receiving AOR can then assign the lead as above, or the lead may be assigned automatically.

Leads Transfer To Admin: It should be noted that the lead record is not technically transferred to the Admin. The USER_ID of the record does not change during the instant process. By pressing the “TRANSFER” button in offline program 30, the recruiter can select a lead record to transfer to another administrative assistant in his/her own AOR. The “Transfer” screen reads the AOR_ID contained in the record and a view displays the corresponding recruiters and administrative assistant from the TUSER table. Selecting an administrative assistant sets a bit “OFFICE_ADMIN_LOCK” to 1 (or true). The code checks this bit and, if true, a function runs that locks out the recruiter from making any changes to this record. The LAST_UPDATED date is also reset. The recruiter must sync, which updates the record on master database 40 and the recruiter's local database 60. When the administrative assistant selects the lead record to modify, a function checks the OFFICE_ADMIN_LOCK bit and, if true, allows the administrative assistant to change the record. In effect, the process transferred administrative rights the record.

SSN Match Reporting: During synchronization process 70, a function runs that compares Social Security Account Numbers (SSN) for lead records already existing on a master server with those on a local server. If a match is found, the function compares the USER_ID of this record in both databases 40, 60. If the SSN match and the USER_IDs match, no action is taken. If the SSNs match and the USER_IDs do not match, a function displays a dialogue box informing the recruiter that an SSN that was synced already existed on the local server. The recruiter can look at the Synchronization Log (described herein below) and click on the “SSN VALIDATION” link, which will display a dialogue box containing the name, SSN, disposition and AOR for any lead records that match. The information is used to eliminate duplicate entries and help identify “Station Jumpers” (i.e., applicants that may have been rejected by another office and are now attempting entry through another).

Change Log: The program manager maintains a table that effects a dialogue box which appears at the end of synchronization process 70. The dialogue box contains a chronological list of changes, additions or modifications to offline program 30, forms or policies, and is intended to improve communications between the program manager and the recruiters.

Synchronization Log: A “synchronization wizard” displays the various tasks synchronization process 70 is performing so that the user can monitor the progress of same. Progress bars are displayed showing the stage of process 70 and what is being check, updated or removed. As such, the synchronization log provides invaluable information for troubleshooting process 70, if a problem should occur. Information about process 70 is also displayed in a “tree” format, which includes the time of the last sync, and the specific action taken during the sync (e.g., number and name of lead records updated).

System 10 also preferably facilitates paperwork management. If a lead record originated nationally, or is entered locally, it is now preferably resident on local database 60, or can downloaded onto the recruiter's laptop L computer, wherein the recruiter can work with the lead in a highly visual environment, with leads appearing in a TREEVIEW listing, which separates and color-codes the leads according to status. Preferably, a recruiter may click on the lead's name to display the initial processing document and the “Prospect Data Card” (PDC), wherein the PDC contains basic lead information and acts as a data entry portal for more complete lead and contact information, for updating of essential basic information, and for changing the status of the lead. When the PDC is displayed, the file tree preferably expands to show all the forms or documents required by the particular program for which the applicant is applying. The recruiter may then preferably select the appropriate forms as needed to complete the applicant package, as more fully described below.

Specifically, all lead records contain a “disposition” field, which indicates the appropriate phase of processing that the applicant is currently in. All new lead records are automatically set, by default, to a “MAKE LEAD” designation, wherein the leads are displayed in a “MAKE LEAD” folder on the desktop file-tree. Leads that have never been viewed by a recruiter are color-coded blue, wherein the last name, first name and middle name of the lead are displayed. Further, leads can be assigned to the administrative assistant, in which case the system “locks-out” the relevant leads, color-coding them red until the assistant releases them back into the system, This latter function is useful for cases where the assistant needs to follow-up on data needed from the lead before further processing.

If the lead is not valid or the recruiter determines that the lead is disqualified in some way, the disposition of the lead can easily be indicated, resulting in statistical information for further analysis. If the lead is to be advanced further through the recruiting system, the recruiter can open a collection of on-screen forms, such as a “Pre-Screen package,” which allows the recruiter to input additional information on electronic forms that appear exactly as the standard pre-printed forms. Once filled out, the forms can be printed out to exact specifications that make them virtually indistinguishable from the pre-printed standard forms that they are designed to replace.

Preferably, offline program 30 contains more than 250 forms, wherein each form serves as a data portal, and wherein data from each form is entered and saved into the local database 60 and is made available to automatically populate other forms that may require the same data. This feature preferably enables one-time data entry. In other words, any form in the system can act as a data entry portal without having to re-type any information already obtained from the original incoming lead or from data typed into another form. Such a feature greatly increases the recruiter's productivity, as the recruiter can quickly move through several forms that have similar information.

Preferably, form images are prepared by a program manger utilizing SCANSOFT'S OMNIFORM DEVELOPER software, or the like, wherein source documents are delivered to the program manager in electronic or paper form and are subsequently scanned and converted to an OMNIFORM format. Preferably, once the form has been completed, the form is converted to a proprietary XFML format and is stored in a documents folder, wherein the program manager ensures that the form data structure is in alignment with databases 40, 60, and makes any database modifications that are required. Preferably, the form is then deployed to the local user, wherein the user may select the form from the file tree. Preferably, the form will load onto the desktop active window, wherein the form will possess the data that is available in local database 60. Preferably, the recruiter is thereby able to quickly ascertain the data needed to complete the form, wherein the recruiter may gather the needed data and enter same into the form, and wherein any data entered into a form is stored in the database when the user selects the “SAVE” button on the icon bar.

Many functions of system 10 are reactive to the data input. For example, selecting certain checkboxes on the program check-off sheet will preferably cause the file tree to display different forms, thereby enabling customization of the file tree for each applicant's unique situation. The forms themselves also preferably contain mathematical and other functions that react to data input.

Preferably, once the forms have been completed and saved, the user may print a selected form at any time. Preferably, upon selection of a print icon, a “Printer Dialogue” box form is displayed, wherein the user may select numerous print options, such as, for exemplary purposes only, number of copies and print quality. Preferably, all data is stored in the system's databases; thus, any form can be recovered and modified easily should any data change or if duplicate copies are needed.

The present system 10 also assists the recruiter by automating several routine tasks, such as launching MICROSOFT WORD, MICROSOFT OUTLOOK email, and MICROSOFT POWERPOINT, as well as sending out questionnaires. Additionally, through stored procedure 26, several analysis reports are automatically generated daily by the system and emailed to management personnel, and other in-depth analysis reports can be run on demand for various time periods and with varying criteria. This assists in judging media effectiveness and developing metrics on cost per recruiting session and other essential measurements of efficiency.

System 10 further preferably comprises advanced features to offer the recruiting command staff and the program manager command and control functions and system maintenance features. Preferably, such features exist in all user installations but are reactive to the security role settings found in the user profile.

Preferably, system 10 delivers a variety of predefined reports to all authorized personnel, wherein such reports are prepared on regular schedules utilizing CRYSTAL REPORTS software and a series of stored procedures. Preferably, reports are made available to the command staff and marketing and fulfillment personnel via central website 50, wherein such reports can be viewed from the website or downloaded to a local terminal. Preferably, many reports are very complex and contain invaluable information, such as, for exemplary purposes only, marketing effectiveness, recruiting applicant demographics, and recruiter efficiency. Many of the reports are also preferably forwarded to Coast Guard Headquarters and/or other governmental agencies. As a related matter, and as described hereinabove, all data collected during in offline local database 60 is transferred back to the central server during each synchronization, enabling reporting and analysis of lead disposition and media effectiveness at the levels of recruiter, AOR, region, or nationwide.

Preferably, in addition to predefined reports, system 10 possesses a strong “AD-HOC” report capability, wherein custom reports may be quickly generated which allows command personnel and program managers to extract and make available information stored in any of the nearly 5000 data fields in the databases of system 10. Such report capability is an extremely powerful tool that preferably provides the decision makers with vital information in a timely and reactive manner. Preferably, such reporting is especially valuable in situations that are outside the normal reporting scope, wherein the data needed may not be available in a predefined report.

Preferably, while most reports contain recruiting data, several reports are designed to provide data to the leadership concerning recruiter activity. For example, reports are preferably created that provide supervisors with information concerning a particular recruiter's ability to convert leads to accessions, or to enlist the requested demographic profiles. Other reports are preferably created that detail a particular recruiter's usage of system 10. Preferably, utilizing this report, supervisors can ensure that the recruiters are utilizing system 10 properly, are synchronizing as required, and are reacting to any changes to system 10 in the appropriate manner. The program manger can preferably utilize these reports to identify any problems that recruiters may be having and recommend changes to the program or the business rules for utilizing same, as well as make training recommendations.

Preferably, to facilitate the recruiting process, system 10 is constantly updated and modified to keep pace with the ever-changing recruiting environment. Therefore, the program manager and the command staff are preferably provided with the tools that allow them to add or modify users, update forms, modify the database and adjust business rules and processes when needed. Accordingly, system 10 preferably provides such tools in either offline program 30 or on central website 50.

Preferably, when a user having a security role of “recruiter” logs on to central website 50, the user is presented with a management screen, or main page, which allows access to all administrative functions appropriate for this security level. Preferably, from this screen, the user may search all of the system's databases for a specific record, log into an FTP site to download programs, software patches or informational files, and access information regarding recruiting offices. Preferably, this site is primarily informational and has very little control or administrative capability.

Preferably, when a user having a security role of “RIC” logs on to the central website 50, the user is presented with a management screen which allows access to many more administrative functions appropriate for this security level. The RIC-user preferably has access to all of the functions available to the recruiter-user, as well as full control of the RIC screens. Preferably, the RIC screens are accessed by selecting the “RIC PAGE” button on central website 50, wherein the RIC control pages are presented in a new window. From the RIC control pages, the RIC can preferably view lead information, view predefined reports, set up automatic lead assignment criteria, search the system's databases, and administer AOR information. Information is also preferably provided on Class A-school schedules and other command level administration.

The present system 10 further provides access to the data developed by the recruiter for other uses, such as for reservations personnel to properly schedule new enlistees into training sessions and to confirm incentives and bonuses that apply to a specific enlistee.

Additionally, because of the sensitivity of personal data collected during the recruiting and interviewing processes, system 10 is designed to fully comply with the HIPAA privacy regulations. This means that individual pieces of data can be marked in the system as HIPAA-protected, causing them to be hidden from anyone not having sufficient security access rights to view them. The system administrator can indicate through an administrative interface which individual types of data should be HIPAA protected, and can control the security access levels of all users.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

1. An automated method of recruiting accession and paperwork management, comprising the steps of:
a. receiving from a variety of sources lead information about possible recruits;
b. storing and managing said lead information in a networked database system;
c. making said lead information available to recruiters to facilitate contacting the recruits; and,
d. synchronizing said networked database system for uniformity of said lead information thereacross.

2. The method of claim 2, wherein said step a. comprises capturing national lead data and storing said national lead data in a master database of said networked database system.

3. The method of claim 2, wherein said step a. comprises entering local lead data into a local database of said networked database system.

4. The method of claim 3, wherein said step b. further comprises the step of assigning a unique identifier to each piece of said lead information stored in said networked database system.

5. The method of claim 4, wherein said step b. further comprises the step of evaluating said national lead data to determine an appropriate recruiting office in which to assign said national lead data for follow-up.

6. The method of claim 5, wherein said step b. further comprises the step of extracting zip code information from said national lead data and comparing said zip code information against a zip code table, said zip code table corresponding to a recruiting office, and assigning said national lead data to a recruiting office that corresponds with said zip code.

7. The method of claim 6, wherein said step b. further comprises the step of screening all said lead information against a matrix of minimum enlistment standards prior to said step c.

8. The method of claim 6, further comprising the step of providing said national lead data to a recruiter-in-charge of a respective receiving office through a central website, wherein said national lead data is presented in chronological order based on date of receipt within said master database.

9. The method of claim 8, further comprising the step of tasking the recruiter-in-charge with assigning said national lead data to subordinate recruiters via a manual assignment process or an automated assignment process.

10. The method of claim 9, wherein said manual assignment process comprises the step of providing said national lead information to a subordinate recruiter for access through said central website, or through an offline program following implementation of said step d.

11. The method of claim 10, wherein said automated assignment process comprises the step of predetermining and setting assignment of specific national lead data to a specific subordinate recruiter based on specific criteria.

12. The method of claim 11, further comprising the step of automatic report generation or downloading of said national lead data assigned to each subordinate recruiter.

13. The method of claim 12, further comprising the step of gathering the final disposition, value and relevance of said national lead data, and reporting same to recruiting command at every step of said method, thereby “closing the loop” of data flow.

14. The method of claim 13, wherein said step d. further comprises the step of comparing said national database with said local database and bringing said lead information thereof into alignment.

15. The method of claim 14, further comprising the step of comparing said unique identifiers of said lead information and adding said lead information from either said national database or said local database to either said local database or said national database, respectively, to ensure uniformity of said lead information thereacross.

16. The method of claim 15, further comprising the step of comparing last-updated and last-sync date-times between said master and said local databases, and giving precedence to any said lead information having a younger or more recent date-time than that stored within said databases.

17. The method of claim 16, wherein said step d. further comprises the step of updating code, forms, and database structures with current versions of same.

18. The method of claim 13, further comprising the step of modifying and comparing database structures of said local and said master databases to bring said local database into alignment, structurally, with said master database.

19. The method of claim 18, wherein said step of modifying and comparing database structures is performed at the beginning of every synchronization of said step d. to ensure that subsequent steps will not be interrupted due to database misalignment.

20. The method of claim 13, further comprising the step of assigning a temporary unique identifier to local lead data on said local database so that said lead information within said master and said local databases can be tracked.

21. The method of claim 20, further comprising the step identifying said local lead data on said local database that comprises said temporary unique identifier, and overwriting said temporary unique identifier with a permanent unique identifier assigned by said master database, and thereafter, updating said databases.

22. The method of claim 13, further comprising the step comparing Social Security Account Numbers of the possible recruits of said lead information to eliminate duplicate entries and identify possible recruits that may have been rejected by another office and are now attempting entry through another.

23. The method of claim 1, further comprising the step of providing forms that serve as a data portal, wherein data from each said form is entered and saved into said networked database system, and is made available to automatically populate other forms that may require the same data; thereby, providing one-time data entry.

24. The method of claim 1, further comprising the step of delivering a variety of predefined reports to command staff and marketing and fulfillment personnel via a central website, wherein said predefined reports comprise information selected from the group consisting of marketing effectiveness, recruiting applicant demographics, recruiter efficiency, lead disposition, media effectiveness, number of leads converted to accessions, number of recruits enlisted from requested demographic profiles, frequency of implementation of said step d., and combinations thereof.

25. An automated method of recruiting accession and paperwork management, comprising the steps of:
synchronizing lead data of a master database with lead data of a local database.

26. The method of claim 25, further comprising the step of performing a total database structure check to determine if a specific script must be run on said local database to modify said master database.

27. The method of claim 26, further comprising the step of automatically launching scripts to bring said local database into alignment, structurally, with said master database.

28. The method of claim 25, further comprising the step of performing a tables check to ensure that all tables of said master database also exist on said local database, wherein if a table is not found on said local database, a script runs to add same.

29. The method of claim 25, further comprising the step of performing a files check by comparing documents within said local database directly with a files table within said master database, and adding files that are listed in said files table, but not in a documents directory of said local database, to said local database.

30. The method of claim 25, further comprising the step of transferring said lead data from said master database to said local database based upon comparison and matching of unique identifiers associated with said lead data with unique identifiers of a recruiter; thereby, enabling the recruiter to access said lead data from said master database through said local database.

31. The method of claim 30, further comprising the step of comparing last-updated and last-sync date-times between said master and said local databases, and giving precedence to any said lead data of either said master or said local databases having a younger or more recent date-time than that stored within said databases; thus, ensuring that both said databases contain identical data.

32. The method of claim 25, further comprising the step of assigning a temporary unique identifier to said lead data on said local database so that said lead data within said master and said local databases can be tracked.

33. The method of claim 32, further comprising the step identifying said lead data on said local database that comprises said temporary unique identifier, and overwriting said temporary unique identifier with a permanent unique identifier assigned by said master database, and thereafter, updating said databases.

34. The method of claim 25, further comprising the step of assigning said lead data of either said master or local databases to a first party for follow-up.

35. The method of claim 34, further comprising the step of transferring said lead data of either said master or local databases from the first party to a second party and, thereafter, synchronizing said databases to reflect reassignment of said lead data to the second party.

36. The method of claim 25, further comprising the step of comparing Social Security Account Numbers of possible recruits of said lead data of either said master or local databases to eliminate duplicate entries and identify possible recruits that may have been rejected by another office and are now attempting entry through another.

37. An automated system of recruiting accession, comprising:
a master database receiving national leads;
a local database receiving local leads; and,
a synchronization process for establishing uniformity of said national leads and said local leads across said master database and said local database.
